(19) United States
(12) Patent Application Publication
(10) Pub. No.: US 2003/0069832 A1
(43) Pub. Date: Apr. 10, 2003

(54) Method for attracting customers, on-line store, assembly of web pages and server computer system

(76) Inventor: Ralf Czepluch, Herrenberg (DE)

Correspondence Address: HEWLETT-PACKARD COMPANY, Intellectual Property Administration, P.O. Box 272400, Fort Collins, CO, 80527-2400, US

(21) Appl. No.: 09/971,944

(22) Filed: Oct. 5, 2001

(51) Int. Cl. G06F 17/60

(52) U.S. Cl. 705/37

(57) ABSTRACT

The invention is directed to a method for attracting customers to an e-commerce supplier's on-line representation, wherein an on-line game is provided for the customers within the, or linked to, the on-line representation; a customer who plays the game gets a reward or a prospect of a reward; wherein the game has to be played repeatedly by the customer in order to get the reward or increase or maintain the prospect of the reward. The invention is also directed to a corresponding Web store, an assembly of Web pages and a computer server system.

### FIELD OF THE INVENTION

The present invention relates generally to electronic commerce (e-commerce), and more particularly to a method for attracting customers to an e-commerce supplier's on-line representation, an on-line store, an assembly of Web pages representing an e-commerce supplier's on-line e-commerce representation and a server computer system.

### BACKGROUND OF THE INVENTION

A primary operational function of any enterprise—selling goods and services to other enterprises and to individual consumers—can advantageously exploit network computing, particularly with the growing ubiquity of the Internet. The selling of goods and services among enterprises and to individual consumers comes under the general heading of commerce, and when supported by networked applications, it is called e-commerce. E-commerce provides many benefits for enterprises and individual consumers, for example reducing costs (administrative and overhead), delay and errors. E-commerce also opens up entirely new channels, such as selling goods and services directly to consumers over the Internet, and improves management decisions by providing more timely, complete and accurate information (see, for example, David G. Messerschmitt: Understanding Networked Applications, 2000, page 83).

Commercial transaction involving a seller and a buyer commonly involves the following four basic steps: Matching buyers and sellers; negotiating terms and conditions; consummation; and customer service (see Messerschmitt, pages 84-86). The present invention mainly deals with the first step, matching buyers and sellers.

The typical mechanisms for matching buyers and sellers are: catalog; advertising; and recommendation. The seller publishes a catalog of goods and services for sale and makes it available for a large collection of willing buyers to access at their initiative. Searching and navigation tools enable the buyer to find appropriate sellers. Further, the seller may make a large collection of potential buyers aware of its goods and services for sale by attaching advertisements to other publications interested buyers may access. For example, the advertisement takes the form of a banner that also serves as a hyperlink to the seller's site. Further, a customer (e.g. a buyer or potential buyer), may be led to a particular supplier (e.g. seller of a good or service) by a recommendation from another satisfied customer (see Messerschmitt, pages 85 and 86).

It has been recognized that on-line games may be another powerful advertising and marketing tool for the Internet (see, for example, Jane Chen et al.: Can Advergaming be the Future of Interactive Advertising?, undated, http://www.kpe.com/ourwork/viewpoints/viewpoints.advergaming_4_.shtml).

In particular, it has already been known to provide an on-line game in the context of a Web store in order to attract customers to the Web store. For example, the Web store www.klangundkleid.ch provides an on-line game in the form of a “treasure hunt”: The customer has to find “coins” which are distributed over the several Web pages of the Web store. If the customer finds a certain number of coins, he or she can take part in a quiz. If the customer completes the quiz successfully, he wins a prize which may be one of the Web store's products.

www.sitebranding.com proposes the integration of a puzzle into a vendor's web site. The puzzle pieces are distributed over several pages (“links”). After the customer has finished retrieving all the puzzle pieces from the designated links, he or she will be offered a reward, for example in the form of a coupon, or free gift.

U.S. Pat. No. 5,710,887 assigned to Broadvision, Inc. discloses an electronic commerce application. A corresponding electronic commerce application is commercially available from BroadVision, Inc. under the trade mark One-To-One.

### SUMMARY OF THE INVENTION

The invention provides a method for attracting customers to an e-commerce supplier's on-line representation. An on-line game is provided for the customers within the, or linked to the, on-line representation. A customer who plays the game gets a reward or a prospect of a reward. The game has to be played repeatedly by the customer in order to get the reward or increase or maintain the prospect of the reward.

According to another aspect, the invention provides an on-line store in which an on-line game is provided for customers within the, or linked to the, online store. The on-line store is arranged in such a way that a customer who plays the game gets a reward or a prospect of a reward. The game has to be played repeatedly by the customer in order to get the reward or increase or maintain the prospect of the reward.

According to still another aspect, the invention is directed to an assembly of Web pages representing an e-commerce supplier's on-line representation in which an on-line game is provided for the customer. The Web pages are to be sent to the customer over the Internet. They are arranged in such a way that a customer who plays the game gets a reward or a prospect of a reward. The game has to be played repeatedly by the customer in order to get the reward or increase or maintain the prospect of the reward.

Finally, the invention is also directed to a server computer system for providing an on-line game to be played within an, or linked to an, on-line store. The server computer system comprises: a game component which is arranged in such a way that a customer can play the on-line game and can get a reward or a prospect of a reward; a storage component which stores user-specific game data; a game-continuation-identification component which identifies a customer who replays the game in order to get the reward or increase or maintain a prospect of a reward; and a rewarding component which grants the reward to the customer or increases or maintains the customer's prospect of a reward.

Other features are inherent in the system, on-line store, assembly of Web pages and server computer system disclosed or will become apparent to those skilled in the art from the following detailed description of embodiments and its accompanying drawings.

### DESCRIPTION OF THE DRAWINGS

In the accompanying drawings:

FIG. 1 shows a high-level functional architecture diagram of an e-commerce server computer system linked to customers via the Internet;

FIG. 2 is a flow chart of a method for attracting customers carried out by means of the server computer system of FIG. 1;

FIG. 3 illustrates an assembly of Web pages representing a Web store with the functionality shown in FIG. 2;

FIG. 4 illustrates three embodiments of on-line games;

FIG. 5 illustrates two embodiments of how a prospect of a reward is collected and transformed into the reward by repeated playing;

FIG. 6 illustrates two embodiments of how a prospect of a reward is reduced when the time interval between consecutive game-playing sessions is too large.

### DESCRIPTION OF THE PREFERRED EMBODIMENTS

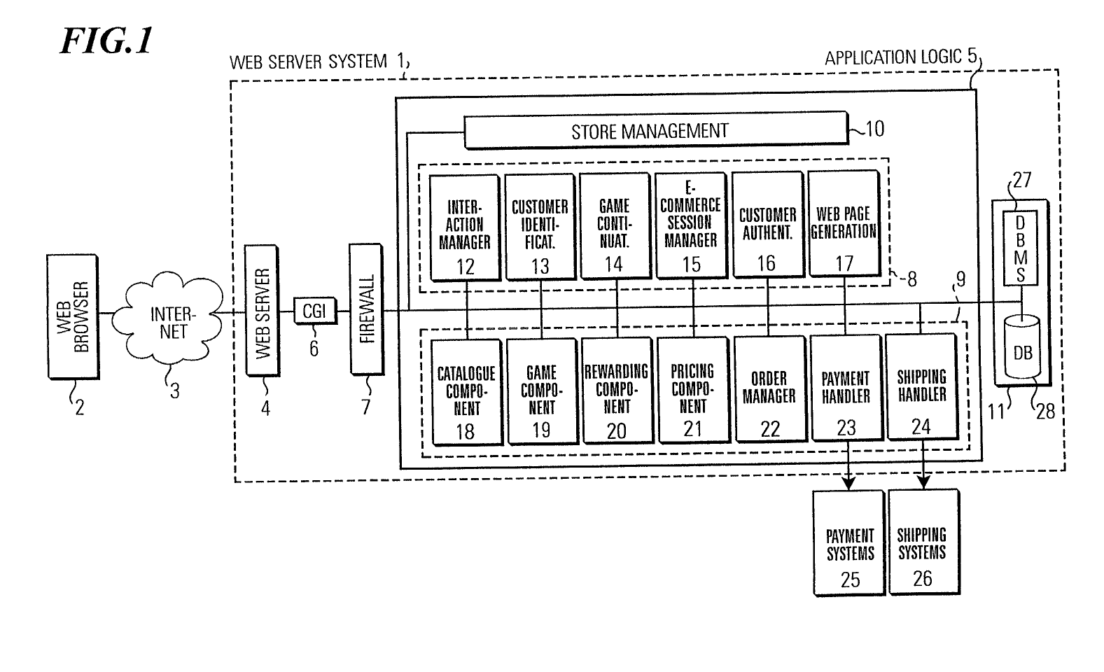

FIG. 1 shows a high-level functional architecture diagram of a preferred embodiment. Before proceeding further with the description, however, a few items of the preferred embodiments will be discussed.

In the preferred embodiments, a method is provided for attracting customers to an e-commerce supplier's on-line representation. E-commerce mainly means the selling of goods and/or services to other enterprises and/or individual consumers supported by networked applications, in particular based on the Internet. In the preferred embodiments, the supplier's on-line representation is a Web store in which the supplier offers its goods and/or services and provides order and payment (and, if applicable, shipping) functionality. The term “attracting customer” does not necessarily mean that the customers are new and visit the Web store for the first time. Rather, it also refers to customers who already know the Web store and visited it in the past. Therefore, attracting customers also means binding customers to the supplier.

In the disclosed embodiments, an on-line game is provided for the customers within the, or linked to the, on-line representation. The on-line game may partly be loaded and executed on the customer's local host in his Web browser. But at least, the overall control of the game is performed on-line over the Internet, for example by the e-commerce supplier or a game service supplier acting on its behalf. The game may be embedded directly in the Web pages forming the Web store (for example, in the Web store's catalog of products and/or services) or can be linked to it, for example by hyperlinks which appear on pages of the Web store. It is likewise possible to combine both possibilities: for example, there may be a separate master game page for the control of the on-line game linked to the page of the Web store (for example to the Web store's homepage) and, further, several elements of the game embedded in pages of the Web store which may be linked to the master game page.

According to the preferred embodiments, the on-line game may be a collecting game, a search game, a puzzle and/or a quiz. Most preferred is a game the elements of which (or links to the elements of which) are distributed over several different Web pages of the Web store so that the user has to visit different pages in order to play the game. Thereby, the customer may be led to visit Web pages which he would not visit otherwise. This enhances the probability that the user becomes aware of additional goods and/or services offered in the on-line store without actively requesting such offers, which corresponds to a push advertisement. The distribution of the game elements over the Web store's Web pages may be static or may be changed with time. By changing the Web pages the playing customer must visit, the game's attractiveness is maintained and the probability that the customer will gather new product information is enhanced. The selection of Web sites that the playing customer must visit can also be made customer-specific according to a known customer's profile. For example, the selection may depend on the customer's personal data (such as age, sex and address) and/or his past buying behavior.

In order to make the game attractive, a customer who plays the game may get a reward or a prospect of a reward. Commonly, the reward or prospect of a reward will only be granted if the customer plays the game successfully, for example if he collects or finds all items of a collecting or search game, finds and correctly combines all items of a puzzle or correctly answers all or the majority of the questions of a quiz. However, if the requirements are intended to be low, it is likewise possible to grant a reward or a prospect of a reward to every customer who plays the game, irrespective of his success, or to make the rewarding dependent on other game-behavior-related parameters, such as the time spent playing the game and/or the number of different pages visited in the course of the game. A prospect of a reward is not yet the reward. Rather, it can correspond to a fraction of the total requirements to get the reward and can only be transformed into the reward if a sufficient amount is accumulated and, optionally, if further requirements are fulfilled. For example, if a customer can get a certain number of points by playing a game (e.g. 10 points) and a higher score is required to get a reward (e.g. 100 points), the 10 points represent a prospect of the reward he gets as a result of the first round. Only after having increased the prospect by collecting 90 more points, will the customer get the actual reward. Another example: it may be required that a game is played a certain minimum number of times (e.g. 3 times) to get a reward. When the customer successfully plays the game for the first time, his game count will be set to one. The game count “1” represents the prospect of the reward he gets from the first playing. Only after having played two more times, and thereby having increased the prospect to “2” and “3”, will the customer get the actual reward.

The reward may be a prize, for example in the form of money, a thing or a service. In the preferred embodiments, however, the reward is a rebate on one or more items offered in the Web store. This binds the customer more strongly to the Web store.

In the preferred embodiments, the game has to be played repeatedly by the customer in order to get the reward or increase or maintain the prospect of the reward. This motivates the customer who has once visited the Web store and played the game to do this again, even if he is not interested in buying anything. The terms “playing the game repeatedly” and “replaying the game” must not only be understood in the narrow sense of “playing one and the same game several times from the beginning to the end” (this is only one of different possibilities). Rather, these terms have a broad meaning in the sense of “playing again after having already played and stopped”. This includes a number of possibilities, for example:

i) resuming a game after an interruption;

ii) playing another round of a game (which may be different from or identical to previous rounds);

iii) playing another game (which may be different from or identical to previous games).

The single act of playing according to one of the different possibilities is also commonly designated as “game-playing session” herein. The different possibilities may be combined, e.g. a first replaying may be a resumption and completion of a first round and a second replaying a playing of a second round of a game.

The games (or rounds) of such a series may be independent from one another and from their position in the series. Likewise, it is possible that one game (or round) depends on previously played games (or rounds) (e.g. on results achieved in the previous game or round) or the position of the game (or round) in the series (e.g. the degree of difficulty may increase from game to game (or round to round).

The game and the rewards offered to the customer may be differentiated in a customer-specific way (e.g. they may depend on the customer's age, sex, etc.), based on known customer profile data. There are several preferred possibilities of how the requirement that the game must be played repeatedly can be implemented. In an embodiment in which the customer can, each time he plays the game, increase his prospect of the reward (e.g. the number of collected points) and, when a certain score (called “reward threshold”) is reached, can get the reward. The requirement may, for example, be implemented by restricting the maximum number of points which can be achieved in one game-playing session to the nth fraction (n=2, 3, 4, . . . ) of the reward threshold. By this measure, it is ensured that the customer has to play at least n times in order to get the reward.

In another embodiment in which the number of times he plays the game (i.e. the number of game-playing sessions) is counted, the requirement may simply be implemented by requiring the game count to be a number greater than one, i.e. n=2, 3, 4, . . .

Further, requirements may be imposed on when the game has to be replayed. For example, in order to exclude any abuse of the reward system, a certain minimum time interval (e.g. one day) may be required between two subsequent game-playing sessions in order to be counted. Similarly, a maximum time distance between subsequent game-playing sessions can be required (e.g. one week) in order to steadily bind the customer to the Web store. If, for example, a customer fails to replay the game within the maximum time interval, he may be penalized by a gradual or sudden reduction of his already-acquired prospect. A sudden reduction may mean that he looses all his already-acquired prospect.

The requirement that the customer must play repeatedly implies that information regarding the previous game-playing session or sessions is available and is brought into relationship with the current game-playing session. If the corresponding data are stored on the supplier's side, this requires the customer to be identified in order to assign the stored data to the current game-playing session. One way of identifying a customer is to require active customer authentication in order to allow access to the Web store. However, this is less preferred since it may deter customers from visiting the Web store. A more preferred way of identifying a customer is based on what is known as the “cookie” technique. A cookie is a little file locally stored on the customer's host by the customer's browser whenever he visits the Web store. The cookie contains information which enables the supplier to identify the customer. (More specifically, the cookie enables the identification of the customer's host since the host does not necessarily “know” who the current operator is. However, no differentiation between the customer and the customer's host is made in the following.) When the customer enters the Web store again (i.e. sends a request for the Web store's homepage to the supplier's server), the cookie file is attached to the request. Based on the received customer-specific cookie information, the supplier can identify the customer, retrieve stored game data about the customer, use them for the present game-playing session in the above-described manner and, optionally, update the game data depending on the results of the present game-playing session. The same identification mechanisms can be used to find and, optionally, update the customer's profile data.

An on-line store can be considered as an assembly of Web pages representing the store, which are sent to a customer as a response to a customer's request together with a store functionality inherent in these pages. An on-line store commonly provides the following functionality: it provides a catalog of goods and/or services for sales; it enables the supplier and the customer to agree on a sale in certain conditions (including price, delivery schedule, etc.); it enables a completion of the agreed sale by payment and transfer or fulfillment of the bought goods or services. Accordingly, an on-line store commonly comprises Web pages which represent a catalog of the goods and/or services for sale (the catalog enables the customer to choose certain goods or services he wants to buy), and pages for choosing certain terms and conditions of the sale (e.g. a delivery schedule or conditions of payment). In the preferred embodiments, the on-line store also has the above-described game functionality and comprises one or more separate game-related Web pages and/or has included game-related content in the above-mentioned catalog and other pages of the Web store.

From the customer's perspective, the Web store is represented by the assembly of the above-mentioned Web pages. The customer can load these Web pages via the Internet (i.e. the world-wide internet using the TCP/IP protocol suite) with the HTTP request-response protocol. The source code of the Web pages is commonly written in the Hypertext Markup Language (HTML) or any other suitable language which may be processible by Web browsers in the future, such as the Extensible Markup Language (XML). The Web pages may include mobile code, such as scripts (e.g. JavaScripts) and/or compiled program applets (such as Java applets). The mobile code can provide for a dynamic appearance of the Web pages at the customer's browser and may even provide for a local interactive game functionality. However, preferably the relevant part of the Web store and game functionality, remains on the server side. Thus, from the customer's perspective this functionality will only show up in a provision of Web pages which are already adapted to the specific transaction situation so that the Web store and game functionality is provided. For example, the question whether a certain article on sale is currently available is not decided locally on the customer's browser since this would require the whole article-availability database to be transmitted to the customer's browser. Rather, when the user selects an item, a corresponding request will be sent to the server. It will then be figured out on the server's side, whether the selected item is available and a response page which is configured according to the outcome of the availability request is returned to the customer. Similarly, the data regarding a previously-achieved game score is preferably not stored at the customer's host (although this option is not excluded), but on the server's side. When the customer replays the game, the pages sent to him are configured in a way which takes account of this data.

The disclosed embodiments also include a server computer system for providing an on-line game to be played within an, or linked to an, on-line store. The server computer system comprises a game component, a storage component, a game-continuation-identification component and a rewarding component. The game component is arranged in such a way that a customer can play the on-line game and can get a reward or a prospect of a reward. Since a customer has to play repeatedly in order to get the reward or increase or maintain his prospect of the reward, the storage component and the game-continuation-identification component are provided. The latter identifies a customer (for example by means of the above-mentioned cookie technique or an active authentication by the customer such as a password authentication). After having identified the customer, the game-continuation-identification component finds out by retrieving game history data from the storage component whether the current attempt to play is a replay attempt. The result of this determination is taken into account by the game component which controls the course of the game. The rewarding component grants the reward to the customer or increases or maintains his prospect of a reward.

It should be noted that this subdivision in several components is functional and does not necessarily imply a corresponding structural division. The functional components can, of course, be merged with other functional components (e.g. the game-continuation-identification component can be merged with a customer authentication component and the storage component may be merged with storage for other functions) or can be made of several distinct functional sub-components.

Returning now to FIG. 1, it shows a high-level functional architecture diagram of a preferred embodiment of a supplier's server computer system 1 and a customer's Web browser 2 coupled to it via the Internet 3. The Web server system 1 comprises a Web server 4 and an application logic 5. The Web server 4 receives HTTP requests from the customer's Web browser 2 and returns HTTP responses in the form of documents which can be loaded, processed and displayed by the recipient (e.g. HTML pages with JavaScripts and/or Java applets) to the customer's Web browser 2. On the other hand, the Web server 4 interacts with the application logic 5 by means of a common gateway interface (CGI) through a firewall 7. There are a number of techniques for writing Web applications which do not use CGI and can be used alternatively, such as Microsoft ASP, PHP, Java servlets and/or Java Server Pages. The Web server 4 forwards the request to the application logic 5 which returns the documents to be sent to the Web browser 2 to it. In the preferred embodiments, the application logic 5 forwards already-completed documents to the Web server 4. In other embodiments, the application logic forwards only variable data which are merged with the invariable parts of the documents at the Web server. The application logic 5 is comprised of an interaction part 8, a transaction part 9, a store management part 10 and a data base part 11.

The interaction part 8 comprises an interaction manager 12, a customer identification component 13, a game continuation component 14, an e-commerce session manager 15, a customer authentication component 16 and a Web page generation component 17. The interaction manager 12 manages the interaction between the application logic 5 and the Web server 4. The customer identification component 13 checks whether cookie data have been received together with a customer's request, analyzes the cookie data and identifies the customer on the basis of the cookie data. It is also responsible for preparing (new) cookies to be sent to the customer's Web browser with the next response. The game continuation component 14 ascertains, based on the customer identification and game history data retrieved from the data base part II, whether the customer has already played a game in the past which he now may continue or repeat. The customer identification component 13 and the game continuation component 14 together form a game-continuation-identification component. The e-commerce session manager 15 recognizes the several requests/responses which together form an e-commerce session. In HTTP the individual requests/responses are not related to one another. HTTP is therefore also called a stateless protocol. Due to HTTP's stateless nature, a session management is usually implemented within an e-commerce application. The individual requests/responses which together form one e-commerce session are therefore bound together under the control of the e-commerce session manager 15, for example by including a unique session identifier to each response belonging to one session in such a manner that the session identifier is sent back by the customer's Web browser 2 with the next request. The customer authentication component 16 comes into action when the customer identification 13 provided by the identification component is not considered sufficient (for example, when an order is submitted). For example, the customer then has to forward his password which is checked by the customer authentication component 16. The Web page generation component 17 assembles information from the different parts of the application logic 5 and generates the Web pages to be sent to the customer's Web browser 2.

The transaction part 9 is comprised of a catalog component 18, a game component 19, a rewarding component 20, a pricing component 21, an order manager 22, a payment handler 23 and a shipping handler 24. The catalog component 18 is responsible for providing the store's catalog, which may be user-specific. The game component 19 provides the game functionality according to which the customer can play an on-line game within the, or linked to the, Web pages of the on-line store during an e-commerce session. The rewarding component 20 grants a reward or a prospect of a reward to the customer or increases or maintains an already-acquired prospect of a reward, depending on the results of the present game-playing session determined by the gaming component 19 and whether the game customer has just started a new series of game-playing sessions or has replayed a previously-started game, as determined by the game continuation component 14. The pricing component 21 determines the prices to be shown in the catalog pages to be sent to the customer. These prices may be customer-specific. In embodiments in which the reward granted to the customer is in the form of a rebate, the prices determined by the pricing component 21 are lowered according to the rebate. The order manager 22, payment handler 23 and shipping handier 24 are responsible for the order, payment and shipping fulfillment. The payment handler 23 and the shipping handler 24 are connected to external payment systems 25 and shipping systems 26, respectively. These external systems may be well-known existing implementations, for example the payment systems 25 may be VISA's computerized credit card network. The database system 11 is comprised of a data base management system (DBMS) 27 and a database 28. It stores all relevant data, such as catalog data, Web page representation data, pricing data, game data, game history data, user profile data etc.

The Web server system 1 can be implemented using standard Web server hardware and software and, for example, an e-commerce application commercially available from BroadVision, Inc. under the trade mark One-Two-One. A description of a similar application can be taken from U.S. Pat. No. 5,710,887 assigned to Broadvision, Inc. The program objects of the BroadVision application are objects in compliance with the Common Object Request Broker Architecture (CORBA). CORBA is a standard for distributed object management and provides a standard definition for the interfaces between the distributed objects (see Messerschmitt, pages 451-453). In the preferred embodiments, the game-related program objects which are not commercially available are written in an object-oriented programming language (e.g. Java or C++) and interfaced with the other program objects in compliance with CORBA. The digital program code representing a part of the Web store can be loaded and executed on the Web server system.

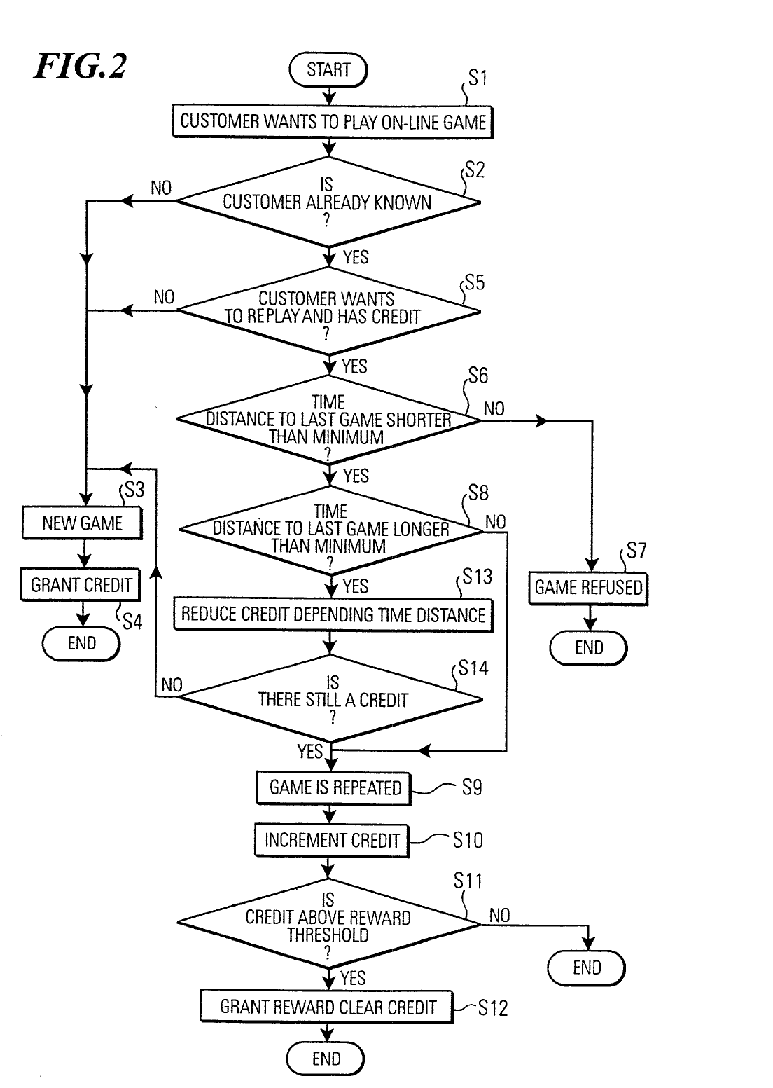

FIG. 2 shows a flow chart of a method for attracting customers carried out by means of the server computer system of FIG. 1. In step S1 a request is received from a customer indicating that he wants to play the on-line game. In step S2, it is ascertained whether the customer is already known. If the answer in step S2 is negative, the user can start to play a new game in step S3 (“new game” means that the customer starts without credit and the present game-playing session is considered as the first one of a series). If the customer plays successfully, he is granted a credit of points in step S4. Then, the method ends.

If, however, the answer in step S2 is positive, it is ascertained in step S5 whether the customer attempts to replay the game and has already a credit of points. If the answer in step S5 is negative, the already-explained steps S3 and S4 are carried out. If, however, the answer in step S5 is positive, it is ascertained in step S6 whether the time distance to the customer's previous game-playing session is shorter than a minimum time interval. If the answer in step S6 is positive, the game is refused in step S7. If, however, the answer is negative in step S6, it is ascertained in step S8 whether the time distance to the customer's last game-playing session is longer than maximum time interval. If the answer in step S8 is negative, the user can replay the game in step S9. If the customer plays the game successfully, his credit is incremented in step S10. In step S11 it is ascertained whether the customer's credit is above a reward threshold. If, however, the answer in step S11 is negative, the method ends. If the answer in step S11 is positive, the customer is granted a reward (e.g. a rebate) and the customer's credit is cleared. After step S12, the method ends. If, however, the answer in step S8 is positive (i.e. if the time distance to the previous game-playing session is longer than the maximum time interval) the customer's credit is reduced in step S13 depending on the length of time. In step S14 it is ascertained whether the customer still has a credit. If the answer in step S14 is negative, the steps S3 and S4 are carried out (i.e. the customer can only start a new game). If, however, the answer in step S14 is positive, steps S9 to S12 are carried out (i.e. the customer can replay the game starting with the reduced credit).

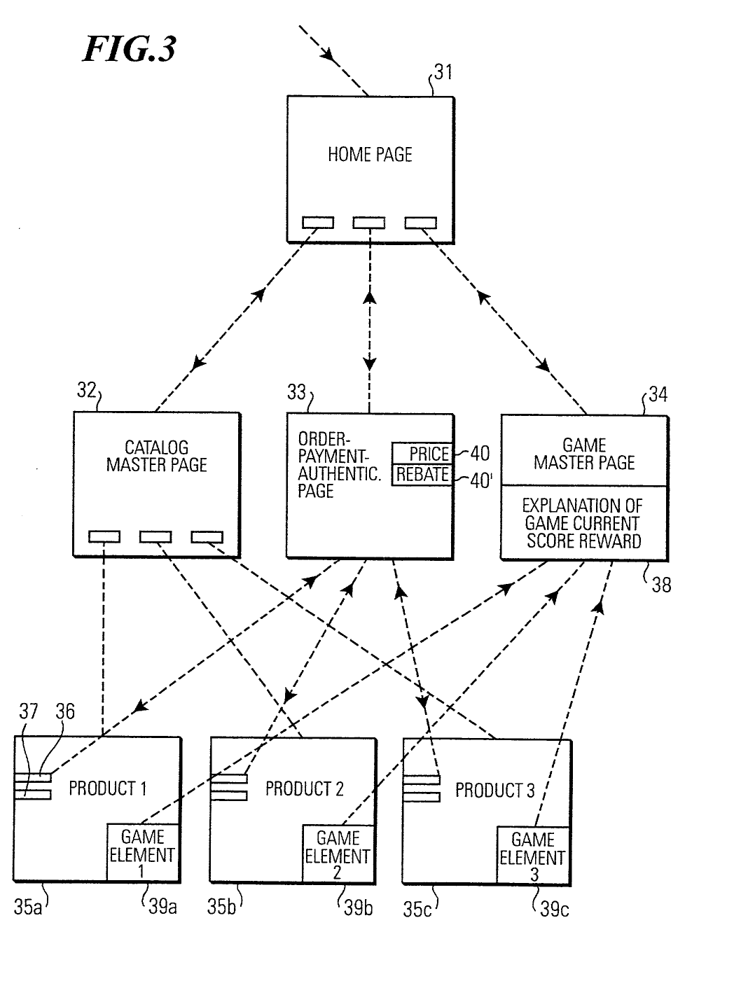

The Web store is an assembly of several related Web pages to which the Web store functionality and the on-line game functionality are inherent, as described above in conjunction with FIGS. 1 and 2. FIG. 3 illustrates an embodiment of such an assembly of Web pages. Commonly, the customer will consecutively load the different Web pages in his Web browser 2, so that only one Web page is visible at a time from his perspective. Only for illustrative purposes, the different Web pages are shown side by side in FIG. 3. Hyperlinks between the Web pages are indicated with broken lines and arrows in FIG. 3. The customer will be led to a homepage 31 of the Web store via a hyperlink from an advertisement banner, a search-engine's result list, etc. or by directly entering the Web-store's domain name. The homepage 31 comprises hyperlinks to a catalog master page 32, an order-payment-authentication page 33 and a game master page 34. In turn, these pages 32, 33 and 34 have hyperlinks to the homepage 31.

In a simple type of Web store illustrated in FIG. 3, the catalog master page 32 in turn provides a multitude of hyperlinks to product pages 35a, 35b, 35c. In more sophisticated Web stores, there is a tree-like structure of index pages between the catalog master page 32 and the product pages 35, and/or the catalog master page 32 is equipped with a search facility which provides in its result list hyperlinks to the product pages 35. Each product page 35 presents a product or a group of products and provides a button 36 which enables the customer to virtually put the product into a basket if he wants to buy it. Further, the product pages 35 have hyperlinks 37 to the order-payment-authentication page 33. When the user has put all the desired products into the basket, he can click onto the hyperlink 37 in order to carry out the order-payment-authentication process in page 33. For customers who are already authenticated and have already provided their payment data, a one-click functionality is likewise possible according to which an order can be carried out by a single click, for example onto button 36.

The game master page 34 comprises a game information field 38 which provides explanation regarding the game, an indication of the current score reached by the customer; an indication of how many points are still needed or how many replays are required to get a reward, and a reward acceptance button if the currently acquired score is already sufficient for the reward. The game itself is subdivided into several game elements 39a, 39b, 39c which appear on the individual product pages 35a, 35b, 35c. The game elements 39 have hyperlinks to the game master page 34 enabling the customer to get the game-related information, like the current score, or, if the user has collected a sufficient score, accept a reward. In the embodiment shown in FIG. 3, there are no hyperlinks from the game master page 34 back to the individual product pages 35 in order to urge the customer who wants play to search through the individual pages of the Web store.

FIG. 3 also illustrates how the grant of a reward—here a rebate—appears in the assembly of Web pages. The order-payment authentication page 33 further contains a price indication 40 and a rebate indication 40′. The price indication 40 indicates, for example, the total standard price of an order. If a customer has exceeded the reward threshold by repeated playing the game and has accepted the reward by clicking on the reward accept button in the field 38, the reward in the form of a rebate is shown by the rebate indication 40′. The customer then only has to pay a price reduced by the rebate.

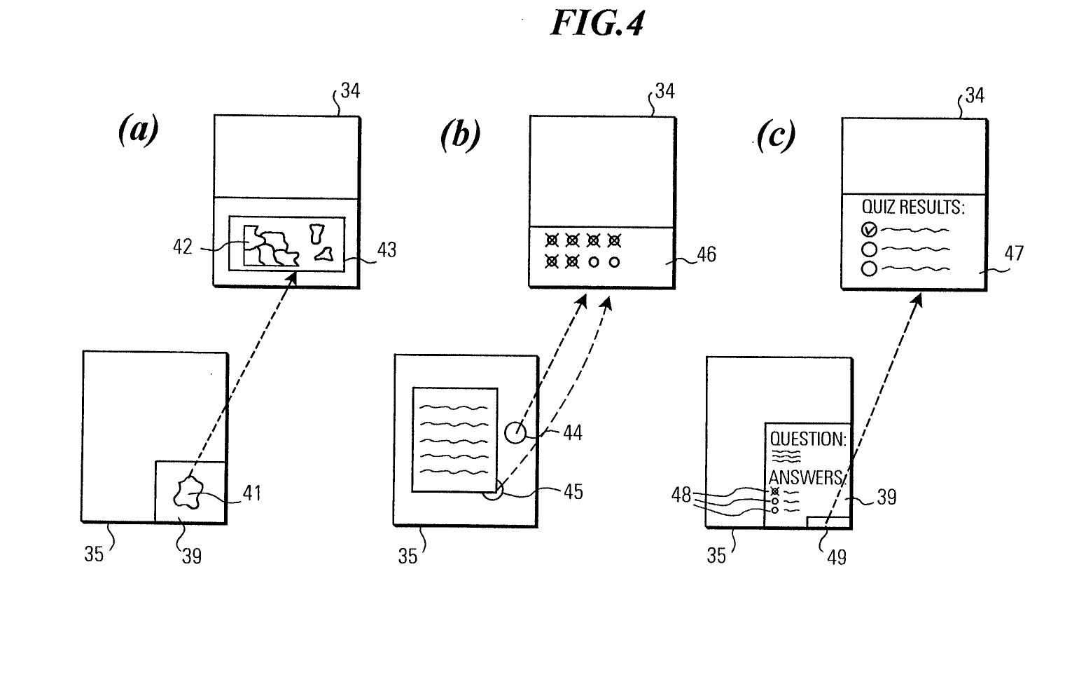

FIG. 4 illustrates different embodiments of on-line games. FIG. 4a shows a puzzle. Each game field 39 of an individual catalog page 35 only contains a fraction of the puzzle items (here only one puzzle item 41) to be collected and assembled to a complete puzzle 42. Upon clicking onto a puzzle item 41, it is virtually transferred into a puzzle field 43 in the game master page 34. Clicking on a puzzle item 41 in a catalog page 35 implies the activation of hyperlink to the game master page 34 so that it is loaded and the customer can immediately try to match the clicked puzzle item 41 with other already-collected puzzle items 41, for example by dragging it with a pointing device (e.g. a mouse) within the puzzle field 43. The replay functionality can be implemented in alternative ways: for example, the user can be required to play the puzzle game several times and to complete the puzzle 42 each time he plays. Preferably, the puzzle is varied from game-playing session to game-playing session in order to make the repeated playing more exciting and to avoid habitual effects. Alternatively, the number of puzzle items 41 collectable per game-playing session could be limited (for example to one item per game-playing session). Then, in order to get the reward, the customer has to play that number of times which is necessary to collect all puzzle items 41 (in the above example, he would have to play n times, wherein n corresponds to the total number of puzzle items 41 in the puzzle 42).

FIG. 4b illustrates a game which is partly a collection game and partly a search game (in other embodiments (not shown) the game is either a collection or a search game). The game comprises items 44, 45 which are distributed over the individual catalog pages 35. There are collection items 44 which are easily recognizable if the corresponding catalog page 35 is loaded. Further, there are search items 45 which are hidden among the contents of the catalog pages 35. To find them, the customer has to closely examine the catalog pages 35. When the customer has noticed an item 44, 45, he can virtually collect it by clicking on it. As a consequence, the item is transferred to an item collection field 46 in the game master page 34. Clicking onto an item 44, 45 in a catalog page 35 may also activate a hyperlink to the game master page 34 so that this page is loaded and the customer is immediately informed about the current status of the game. Similar to the embodiment of FIG. 4a, there are different alternative ways of implementing the replay functionality. For example, the customer may be required to play several times and to collect all available items 44, 45 each time he plays in order to get a prospect of a reward. The way in which the items 44, 45 are distributed or hidden is preferably varied from game-playing session to game-playing session. According to an alternative possibility, the number of items 44, 45 per game-playing session is smaller than the number required for a reward. Then, in order to get the reward, the customer has to play several times. It should be noted at this point, that a separate game field 39 as shown in FIGS. 3 and 4a is not necessarily required. Rather, the association between the game and the e-commerce contents to which the customer should be attracted can even be enhanced by mixing the game items with the e-commerce contents. For example, in FIG. 4b the items 44, 45 are spread over or even hidden among the catalog-page contents.

Finally, FIG. 4c illustrates a quiz. The quiz is comprised of quiz elements 39 in the catalog pages 35 and a quiz results field 47 in the game master page 34. In the quiz elements 39, a quiz question and several alternative answers with clickable answer buttons 48 are provided. In order to play the quiz game, the customer has to click on one (or, if more than one answer is correct, on several) quiz buttons 48. In the embodiment of FIG. 4c, clicking on a quiz button 48 does not activate a hyperlink to the game master page 34. Rather, a separate hyperlink 49 is provided for this purpose in order to allow the customer to correct his choice before jumping to the game master page 34. The quiz results list 47 provides the customer with an overall view of the quiz results achieved so far. As with FIGS. 4a and 4b, there are several possible ways of implementing the replay functionality. For example, in one embodiment, the user has to play several times and has to answer all quiz questions distributed over the catalog pages 35 each time he plays in order to get a prospect of a reward. Upon replaying the quiz game, the user has to answer another set of (different) quiz questions. Alternatively, the number of quiz questions that can be answered in one game-playing session may be limited (for example to one), and the user gets a reward only if he answers all questions. This urges him to replay the quiz game.

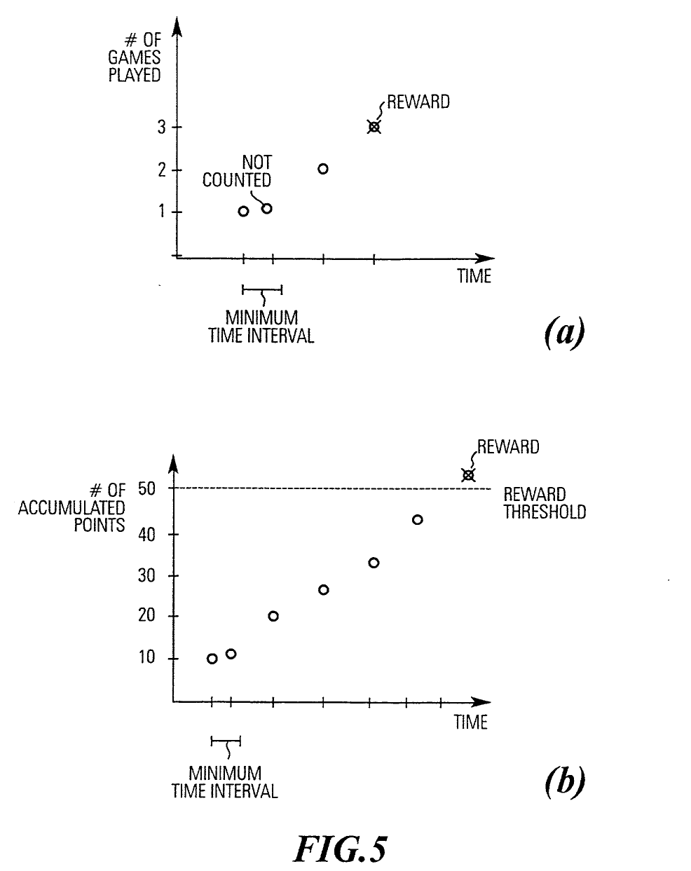

FIG. 5 illustrates two embodiments of how a prospect of a reward is collected and transformed into the reward by repeated playing. In the embodiment of FIG. 5a the number of successful game-playing sessions is counted. The total number of successful game-playing sessions represents the prospect for the reward, and each successful game-playing session increases this prospect. In the example shown, three such game counts are required in order to get the reward. In order to be counted, the replay must respect a certain minimum time interval indicated with a bar in FIG. 5 to the previous game-playing session. In the example of FIG. 5a, the customer plays for the first time and obtains one game count. Then, he plays for the second time; however, the time distance to the first game-playing session is shorter than the required minimum time interval so that the second game is not counted. The third game-playing session is at a sufficient time distance from the first game-playing session, but not from the second game-playing session. However, since the second game is not counted, the third game is accepted and the customer gets his second game count. The fourth game-playing session is at a sufficient time distance from the third one, so that the game count is increased to three. Since the customer has now reached the required number of game counts, he can transform them into the reward.

The second embodiment according to FIG. 5b corresponds to the one of FIG. 5a, apart from the fact that the customer can collect points as prospect of a reward, and a certain number of points if required to get the reward. The maximum number of points obtainable per game-playing session is smaller than the required total number of points, which encourages the customer to play repeatedly in order to get the reward. In the example shown in FIG. 5b the maximum number obtainable per game-playing session is 10, and the required total number of points (i.e. the reward threshold) is 50. In the example, the customer had to play seven times in order to reach the reward threshold and get the reward since one game has not provided any points due to a failure to comply with the minimum time interval requirement, and in other games the customer has only achieved less than the maximum number of points.

There are different possible ways of implementing the minimum-time-interval requirement. In a first embodiment (not shown), after a completion of a game-playing session, the game is disabled and will only be enabled when the minimum time interval has elapsed. According to another embodiment (not shown), only partial game functionalities are available during the minimum-time-interval. For example, in a game in which points can be accumulated, the user can still resume a previous round of the game in order to improve his score. However, the next round of the game cannot be commenced before the minimum time interval has elapsed. According to still another alternative (shown in FIGS. 5a and 5b), playing is allowed but not counted if it happens before the minimum time interval has elapsed.

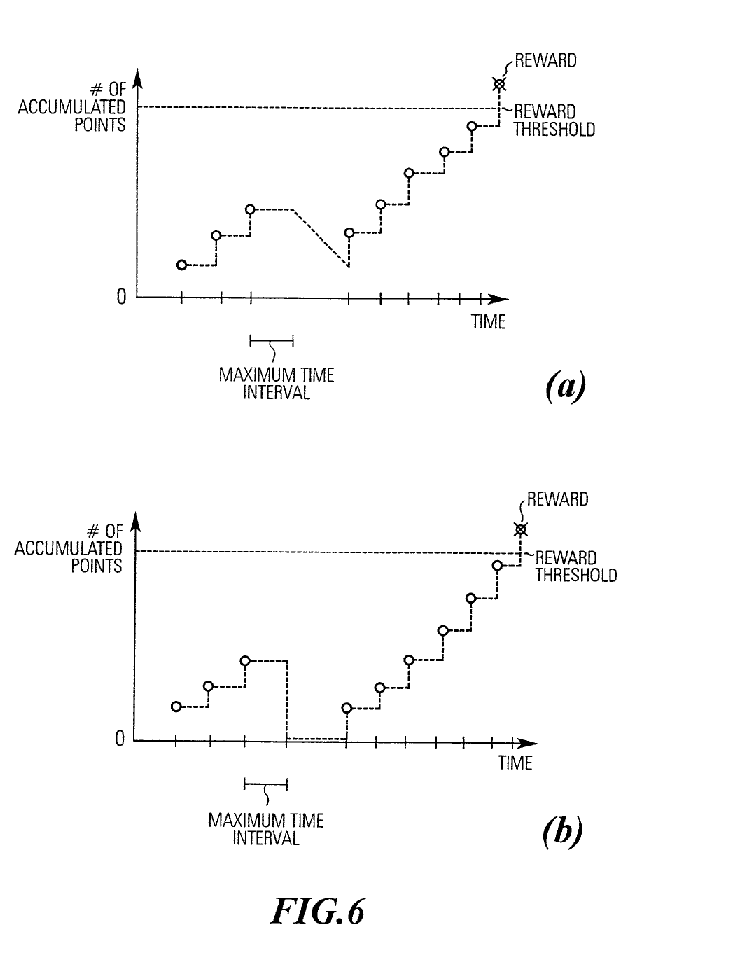

FIG. 6 illustrates two embodiments of how a prospect of a reward is reduced when the time distance between two subsequent game-playing session is greater than the allowed maximum time interval between game-playing session. According to the embodiment of FIG. 6a, the already acquired number of points is decreased gradually with time starting at the point of time at which the game should have been repeated. Since the decrease is gradual, a certain reduced number of points may be left and added to the number of points acquired in the next game-playing session, if the time distance is not too long. In the embodiment of FIG. 6b, however, the number of acquired points is suddenly set to zero at the above-mentioned point of time.

With the preferred embodiments, customers will be more efficiently attracted and bound than was previously the case. Thus, a general purpose of the preferred embodiments is to provide an improved method, on-line store, assembly of Web pages and server computer system.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A method for attracting customers to an e-commerce supplier's on-line representation,
wherein an on-line game is provided for the customers within the, or linked to the, on-line representation;
a customer who plays the game gets a reward or a prospect of a reward;
wherein the game has to be played repeatedly by the customer in order to get the reward or increase or maintain the prospect of the reward.

2. The method of claim 1, wherein the on-line game is at least one of a collecting game, a search game, a puzzle and a quiz.

3. The method of claim 1, wherein the customer has to visit different pages of the on-line representation in order to play the game.

4. The method of claim 1, wherein the reward is a rebate on items offered in the on-line representation, or a prize.

5. The method of claim 1, wherein, each further time the customer plays the game, the customer can increase his prospect of the reward and, when a certain score is reached, can get the reward.

6. The method of claim 1, wherein the game must be played at least one further time in order to transform a prospect of a reward into the reward.

7. The method of claim 1, wherein the customer has to replay the game a certain minimum number of times in order to get the reward or increase or maintain the prospect of the reward.

8. The method of claim 1, wherein, if the customer does not play a further game within a certain period of time, an already-acquired prospect of a reward is gradually or suddenly reduced.

9. The method of claim 1, wherein the customer has to replay the game periodically in order to get the reward or increase or maintain the prospect of the reward.

10. An on-line store in which an on-line game is provided for customers within the, or linked to the, on-line store;
the on-line store is arranged in such a way that a customer who plays the game gets a reward or a prospect of a reward; and
the game has to be played repeatedly by the customer in order to get the reward or increase or maintain the prospect of the reward.

11. The on-line store of claim 10, wherein the on-line game is at least one of a collecting game, a search game, a puzzle and a quiz.

12. The on-line store of claim 10, wherein the customer has to visit different pages of the on-line store in order to play the game.

13. The on-line store of claim 10, wherein the reward is a rebate on items offered in the on-line store, or a prize.

14. The on-line store of claim 10, wherein, each further time the customer plays the game, the customer can increase his prospect of the reward and, when a certain score is reached, can get the reward.

15. The on-line store of claim 10, wherein the game must be played at least one further time in order to transform a prospect of a reward into the reward.

16. The on-line store of claim 10, wherein the customer has to replay the game a certain minimum number of times in order to get the reward or increase or maintain the prospect of the reward.

17. The on-line store of claim 10, wherein, if the customer does not play a further game within a certain period of time, an already-acquired prospect of a reward is gradually or suddenly reduced.

18. The on-line store of claim 10, wherein the customer has to replay the game periodically in order to get the reward or increase or maintain the prospect of the reward.

19. An assembly of Web pages representing an e-commerce supplier's online representation in which an on-line game is provided for the customer, said Web pages are to be sent to the customer over the Internet;
the Web pages are arranged in such a way that a customer who plays the game gets a reward or a prospect of a reward; and
the game has to be played repeatedly by the customer in order to get the reward or increase or maintain the prospect of the reward.

20. The assembly of Web pages of claim 19, wherein the on-line game is at least one of a collecting game, a search game, a puzzle and a quiz.

21. The assembly of Web pages of claim 19, wherein the on-line game is distributed over several Web pages of the assembly.

22. The assembly of Web pages of claim 19, wherein the reward is a rebate on items offered in the on-line store, or a prize.

23. The assembly of Web pages of claim 19, wherein, each further time the customer plays the game, the customer can increase his prospect of the reward and, when a certain score is reached, can get the reward.

24. The assembly of Web pages of claim 19, wherein the game must be played at least one further time in order to transform a prospect of a reward into the reward.

25. The assembly of Web pages of claim 19, wherein the customer has to replay the game a certain minimum number of times in order to get the reward or increase or maintain the prospect of the reward.

26. The assembly of Web pages of claim 19, wherein, if the customer does not play a further game within a certain period of time, an already-acquired prospect of a reward is gradually or suddenly reduced.

27. The assembly of Web pages of claim 19, wherein the customer has to replay the game periodically in order to get the reward or increase or maintain the prospect of the reward.

28. A server computer system for providing an on-line game to be played within an, or linked to an, on-line store, comprising:
a game component which is arranged in such a way that a customer can play the on-line game and can get a reward or a prospect of a reward;
a storage component which stores user-specific game data;
a game-continuation-identification component which identifies a customer who replays the game in order to get the reward or increase or maintain a prospect of a reward;
a rewarding component which grants the reward to the customer or increases or maintains the customer's prospect of a reward.

29. The server computer system of claim 28, wherein the on-line game is at least one of a collecting game, a search game, a puzzle and a quiz.

30. The server computer system of claim 28, wherein the customer has to visit different pages of the on-line store in order to play the game.

31. The server computer system of claim 28, wherein the reward is a rebate on items offered in the on-line store, or a prize.

32. The server computer system of claim 28, wherein, each further time the customer plays the game, the customer can increase his prospect of the reward and, when a certain score is reached, can get the reward.

33. The server computer system of claim 28, wherein the game must be played at least one further time in order to transform a prospect of a reward into the reward.

34. The server computer system of claim 28, wherein the customer has to replay the game a certain minimum number of times in order to get the reward or increase or maintain the prospect of the reward.

35. The server computer system of claim 28, wherein, if the customer does not play a further game within a certain period of time, an already-acquired prospect of a reward is gradually or suddenly reduced.

36. The server computer system of claim 28, wherein the customer has to replay the game periodically in order to get the reward or increase or maintain the prospect of the reward.
